(19) United States
(12) Patent Application Publication
(10) Pub. No.: US 2002/0140576 A1
(43) Pub. Date: Oct. 3, 2002

(54) Laser parking alignment system

(76) Inventor: Christopher M. Simon, Lewisville, TX (US)

Correspondence Address: Michael L. Diaz, Michael L. Diaz, P.C., Suite 200, 555 Republic Drive, Plano, TX, 75074, US

(21) Appl. No.: 09/821,260

(22) Filed: Mar. 29, 2001

(51) Int. Cl. G08G 1/14; G08B 13/18; B60Q 1/48

(52) U.S. Cl. 340/932.2; 340/557

(57) ABSTRACT

A parking alignment system utilizing a laser to properly align a vehicle within a garage. The alignment system includes a laser emitter which emits a downwardly pointing laser beam. A driver of the vehicle enters the enclosure and stops the vehicle in a specified position providing proper alignment of the vehicle within the garage when the laser beam strikes a specified target indication position located on the vehicle. The parking alignment system may be actuated by a motion detector detecting motion within the garage.

### BACKGROUND OF THE INVENTION

1. Technical Field of the Invention

This invention relates to alignment systems, and more particularly, to a laser system for aligning a vehicle in a specified area.

2. Description of Related Art

It is well known that it can be very difficult to correctly align vehicles within confined areas, such as garages. Many times a driver must estimate the position of the vehicle when aligning it within the garage. If the vehicle is not positioned far enough within the garage, the garage door is unable to be closed. In addition, if the vehicle is parked too far within the garage, the area may be too confined to allow people to traverse in front of the vehicle. Also, in an attempt to position the vehicle far enough within the garage to allow the garage door to close, the driver may accidently hit objects, such as the garage wall. There have been implemented many ways to properly align the vehicle within the garage. Many drivers utilize a stationary object for which the driver estimates the proper distance within the garage. For example, a ball may be attached to the ceiling of the garage, and the driver drives the vehicle until the ball rests against the windshield. However, the ball alignment device does not allow for modification of the size of the vehicle. If a vehicle is a different size, the ball must be removed from the ceiling and repositioned to allow the ball to rest against the windshield when the vehicle is in the proper position.

Additionally, prior alignment systems have used padded bumpers affixed to the walls of garages to indicate when the driver has deviated too much from the correct position of the vehicle within the garage. However, utilizing these bumpers actually provides a late notice to the drive, since the vehicle has actually contacted the bumpers, which may cause damage to the vehicle. An alignment system is needed which is flexible enough to allow any driver of any vehicle to properly align a vehicle within a confined area without potentially damaging the vehicle.

Although there are no known prior art teachings of a device such as that disclosed herein, prior art references that discuss subject matter that bears some relation to matters discussed herein are U.S. Pat. No. 4,808,997 to Barkley et al. (Barkley), U.S. Pat. No. 5,127,357 to Viskovich (Viskovich), U.S. Patent Number to White (White), and U.S. Pat. No. 6,184800 B1 to Lewis (Lewis).

Barkley discloses a position indicating device to assist a driver in positioning a vehicle on a supporting surface. A photoelectric control unit is mounted overhead the area for which the vehicle is to be aligned. A beam emitting device emits a light beam downwardly for interception by the vehicle. The light beam is initially reflected back to a photoelectric transducer on the control unit by a reflective device or mirror. When the light beam is interrupted by the vehicle, the amplifier produces a beam interruption output signal which causes a one-shot timer to energize an alarm device. The operator, upon hearing the alarm, stops the vehicle in the desired position. Although Barkley discloses a light beam for aligning a vehicle, Barkley does not teach or suggest emitting the light beam directly on the vehicle to provide an indication that the vehicle is properly aligned. Barkley suffers from the disadvantage of utilizing several electronic components, thereby providing an expensive and complex system.

Viskovich discloses a garage parking guide to assist a driver in parking a vehicle in the same desired location of an enclosure. The guide consists of an adjustable mirror and housing affixed adjacent to the garage door opening for the purpose of reflecting the vehicle's park lights to the driver via the vehicle's side view mirror. The guide, when properly positioned, directs a visual image to the driver indicating the vehicle's relative position to the garage opening. As the vehicle enters the garage, the brake lights reach a predetermined alignment with that of the parking guide so as to transmit the glow of the brake lights to the driver, which signifies that the vehicle has reached the final predetermined position. Viskovich does not teach or suggest emitting a light from the top of the enclosure to provide an indicator to the driver of the proper alignment of the vehicle. In addition, Viskovich suffers from a serious defect, in which the driver is devoting a great deal of attention to the rear of the vehicle, which could be danger to people or objects located in front of the vehicle.

White discloses a vehicle guidance system which uses a laser to emit a beam of light over the path along which a vehicle is to be guided. The laser beam impinges on a target area located on the vehicle in such a manner that the impingement of the laser beam on the target is continuously observable by the vehicle's operator. The operator steers the vehicle so that the laser beam continuously impinges on the target area until the vehicle reaches a preselected position in a confined space. Although White discloses a laser emitting device to assist in the alignment of a vehicle within a confined area, White does not teach or suggest positioning the laser emitting device overhead the vehicle. White suffers from several major flaws. First, the emitted laser is directed toward the eyes of the driver of a vehicle, which can be very distracting, resulting in a safety hazard. In addition, White requires the modification of the interior of the vehicle in that a target alignment device must be affixed within the vehicle to properly align the vehicle. The target alignment device may not be desired by many vehicle owners, since it may detract from the aesthetic beauty of the vehicle's interior. In addition, the target placement on the vehicle must be meticulously positioned to provide proper alignment for the vehicle.

Lewis discloses a parking aid having a laser pointer which is supported by a mounting bracket configured for removable attachment to the interior of a vehicle's windshield. The mounting bracket houses the laser power source such that the laser is only made operational when it is correctly positioned upon the mounting bracket. The laser is focused forward from the vehicle so that it displays an image on the wall surface in front of the moving vehicle. As the vehicle approaches the wall, the image on the wall surface descents until it reaches a predetermined stopping point, informing the driver that they have reached the proper position. Lewis also does not teach or suggest mounting the laser overhead within the enclosure. Lewis, in a similar fashion as White, requires modification of the vehicle, detracting from the interior's appearance. Additional, Lewis's system may only be used by vehicles having the mounting bracket and laser.

Review of the foregoing references reveals no disclosure or suggestion of a laser alignment system which safely and effectively aligns a vehicle within an enclosure without modifying the vehicle. It is an object of the present invention to provide such a system.

### SUMMARY OF THE INVENTION

In one aspect, the present invention is a vehicle alignment system for guiding a vehicle into a specified position within an enclosure. The system includes an enclosure having a ceiling and a laser emitting a generally downward laser beam. The laser is affixed to a ceiling of the enclosure. The system additionally provides a determined position on the vehicle which requires no modification to the vehicle. When the laser beam strikes the determined position, a driver of the vehicle is provided with an indication that the vehicle is located in the specified position within the enclosure.

In another aspect, the present invention is a vehicle alignment system for guiding a vehicle into a specified position within an enclosure. The system includes a light emitter emitting a generally downward light beam. The light emitter is affixed to a ceiling of the enclosure and may emit any type of light beam. In addition, the system includes a specified target position located on the vehicle. When the light beam strikes the specified target position, a driver of the vehicle is provided with an indication that the vehicle is located at the specified position.

In still another aspect, the present invention is a vehicle alignment system for guiding a vehicle into a specified position within an enclosure. The system includes an enclosure having a ceiling and a laser emitting a generally downward laser beam. The laser is affixed to the ceiling of the enclosure. A motion detector is used for detecting when the vehicle approaches the specified target position. When motion is detected, the motion detector sending a signal to the laser to emit the laser beam. The system also uses a specified target position indicating to a driver of the vehicle when the vehicle is located at the specified position. When the laser emits the laser beam on the specified target position, the driver is provided with an indication that the vehicle is located in the specified location.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1A is a partial side sectional view of a vehicle in a partially parked position within a garage;

FIG. 1B is a partial side sectional view of the vehicle in a fully parked position within the garage;

FIG. 2 is a simplified electrical diagram of the laser alignment system in the preferred embodiment of the present invention;

FIG. 3 is a simplified electrical diagram of the garage door opener attached to a light control box in an alternate embodiment of the present invention;

FIG. 4 is an enlarged partial side view of the laser emitter affixed to a light housing of the garage door opener in the preferred embodiment of the present invention; and

FIG. 5 is a bottom view of the laser emitter in the preferred embodiment.

### DETAILED DESCRIPTION OF EMBODIMENTS

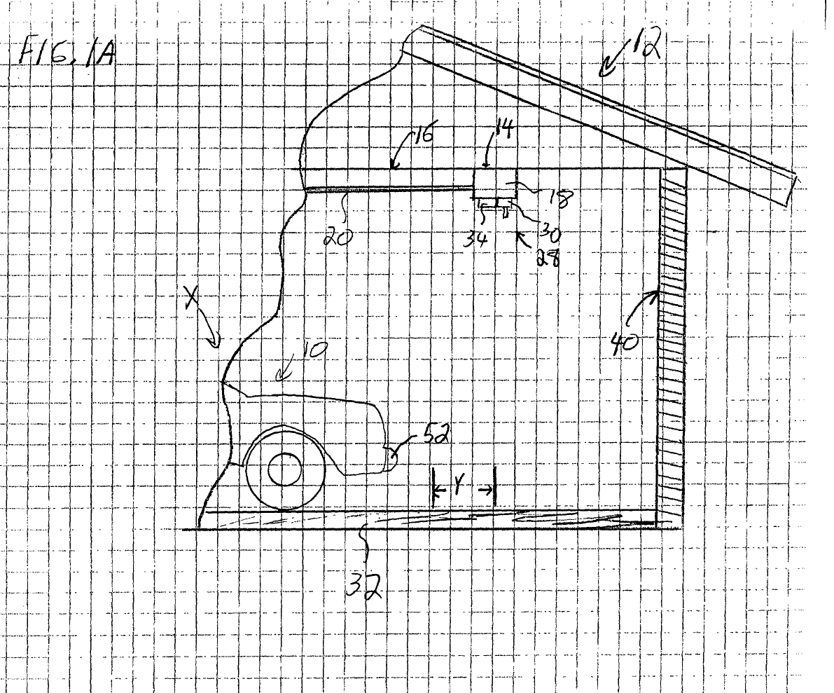

A laser system for properly positioning a vehicle in a specified area is disclosed. FIG. 1A is a partial side sectional view of a vehicle 10 in a partially parked position X within a garage 12. The vehicle may be any vehicle such as an automobile, truck, bus, etc. Although a garage is illustrated, any enclosure having a plurality of walls and a ceiling may be used. A conventional garage door opener 14 is affixed to a ceiling 16 of the garage. The garage door opener includes a motor 18 driving a chain 20 connected to a garage door (not shown).

A laser alignment system 28 includes a laser emitter 30, which is affixed to a bottom portion of the garage door opener 14. The laser emitter emits a laser beam downwardly toward the ground 32. The laser emitter may be any device which emits a light (e.g., laser or infrared light beam) or even an electromagnetic pulse. In the preferred embodiment of the present invention, the laser emitter is a convention 3-volt laser. Adjacent the laser emitter is an optional motion detector 34 for detecting motion over a zone Y directly below the motion detector. The motion detector is well known within the security industry. The motion detector provides a signal to the laser emitter when motion is detected within the zone Y. When the signal is sent from the motion detector to the laser emitter, the laser emitter may be turned on for a specific period of time. By utilizing the motion detector, the use of the laser emitter is limited to the period of times the laser emitter must be operating. In an alternate embodiment of the present invention, the laser emitter is turned off when the garage door is closed or manually turned off by a person. In still another embodiment of the present invention, the laser emitter may be turned on and off by another external signaling source, such as by a garage door remote actuator or a manual switch located in or near the interior of the garage.

As illustrated in FIG.1A, the vehicle 10 is in position X, which is incorrectly aligned in relationship to a front wall 40 of the garage 12. In position X, the vehicle prevents closure of the garage door (not shown). The laser emitter 30, if actuated, would emit a laser beam 50 striking the ground 30.

FIG. 1B is a partial side sectional view of the vehicle 10 in a fully parked position Z within the garage 12. As depicted, the vehicle is in proper alignment in relationship to the front wall 40 to allow the garage door (not shown) to be closed, yet provides a spacing S between the wall and a front bumper 52 to allow movement by people through the spacing S. The spacing also ensures that the front bumper of the vehicle does not contact the wall. While in position Z, the laser beam 50 strikes a target position 54. In this illustration, the target position is located on a dashboard 56 of the vehicle 10. However, this target position varies on the size of the vehicle. Upon initial use of the invention on a particular vehicle, the driver must park the vehicle at the fully parked position Z and determine where the target position 54 is located within the interior of the vehicle. This target position varies from vehicle to vehicle. For example, one vehicle may have the target position located in the middle of the dashboard while another vehicle may have the target position located a few feet forward of the dashboard.

With reference to FIGS. 1A and 1B, the operation of the laser alignment system 28 will now be explained. The vehicle approaches the interior of the garage 12. As illustrated in FIG. 1A (position X), the vehicle has not entered the zone Y. The motion detector 34 does not yet detect any motion within the zone Y. Since no motion has yet been detected, the laser emitter 30 does not receive any signal from the motion detector, thus there is no laser beam produced.

As the vehicle 10 encroaches the zone Y, the motion detector 34 detects motion within the zone Y. The motion detector then sends a signal to the laser emitter 30. In response, the laser emitter produces the downwardly emitting laser beam 50. The laser beam strikes in the same location on the ground 32. However, as the vehicle moves toward the front wall 40, the laser beam strikes the vehicle moving toward the designated target position 54. In our example, the target position is located on the dashboard 56. When the laser beam strikes the dashboard, the driver then knows that the vehicle is properly aligned. Since the target position is located in a convenient location allowing the driver of the vehicle to observe the laser beam location without much effect, the vehicle can safely be aligned within the garage. Additionally, the laser beam is not aimed directly in line with the eyes of the driver, thereby avoiding another distraction for the driver.

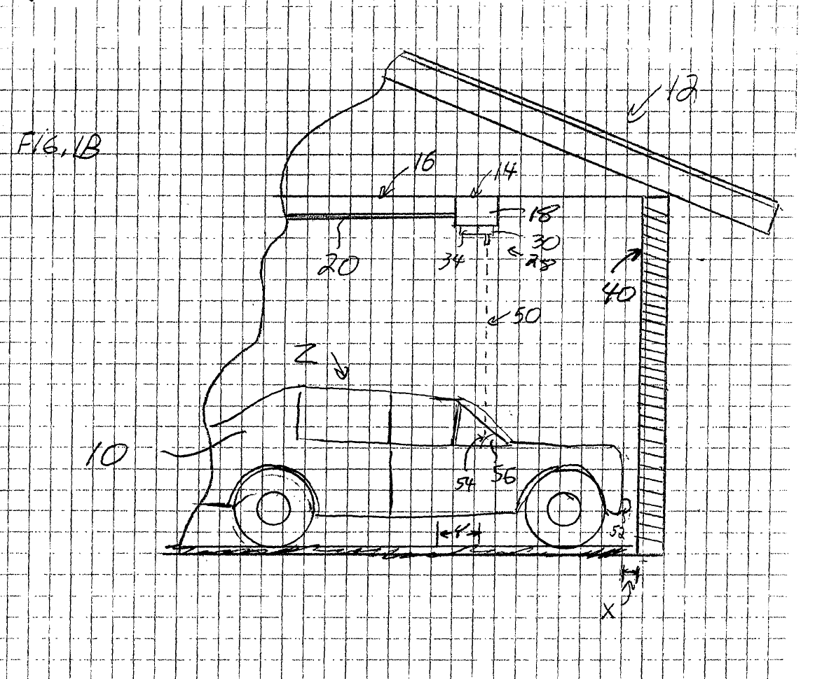

FIG. 2 is a simplified electrical diagram of the laser alignment system 28 in the preferred embodiment of the present invention. The motion detector 34 may be fed a convention 110-volt electrical AC power source from a power supply 60. The motion detector feeds 110-volts to an electrical reducer 62 which reduces the volts from 110-volts to two 3-volt lines 64 and 66, each providing a positive and negative lead to the laser emitter 30 and optionally to a second laser emitter 31. The laser alignment system may include a plurality of laser emitters for use with multiple cars in a garage. Thus, the electrical reducer may provide power for a plurality of laser emitters. In alternate embodiment of the present invention, the laser alignment system may be powered by any electrical power source, such as a DC battery.

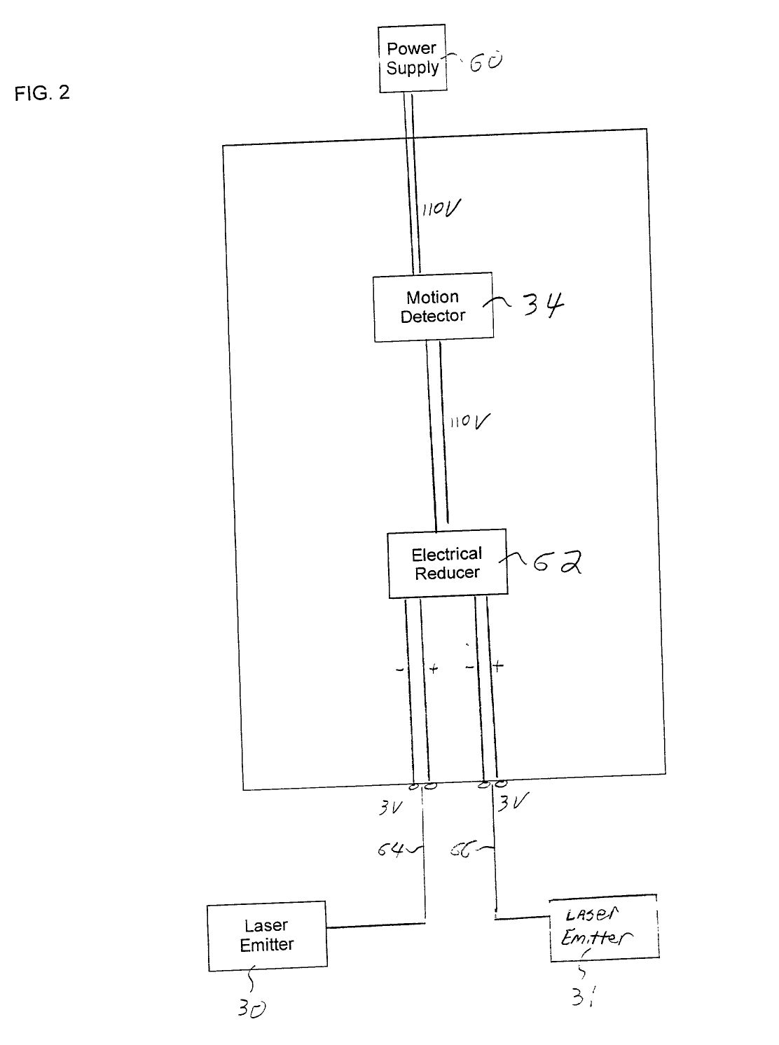

FIG. 3 is a simplified electrical diagram of the garage door opener 14 attached to a light control box 70 in an alternate embodiment of the present invention. As illustrated, the laser emitter 30 may be fed electrical power from the light control box 70 of the garage door opener. The light control box receives power via a 110-volt AC power source and provides power to a light bulb 72, which illuminates the interior of the garage 12. The light control box feeds 110-volt AC power to the electrical reducer 62 which converts the power to two 3-volt power lines useable by the laser emitter 30.

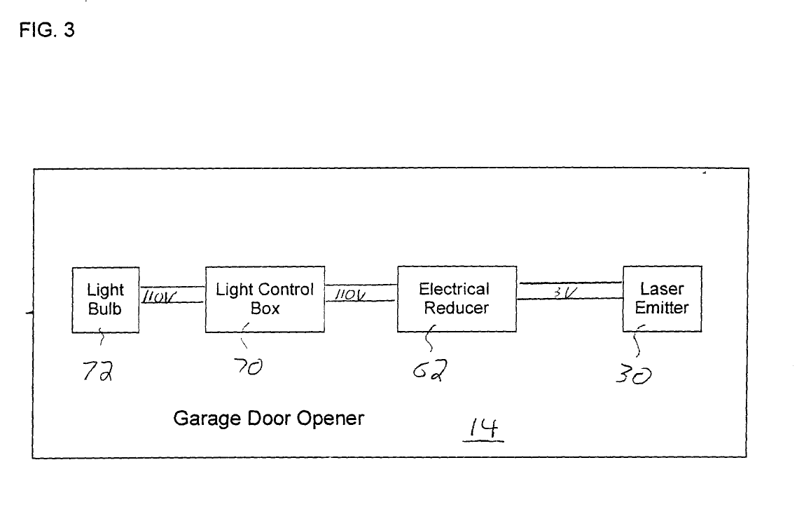

FIG. 4 is an enlarged partial side view of the laser emitter 30 affixed to a light housing 74 of the garage door opener 14 in the preferred embodiment of the present invention. The laser emitter may be affixed directly to an existing garage door opening. As illustrated, the laser emitter is affixed directly to a bottom portion of the light housing.

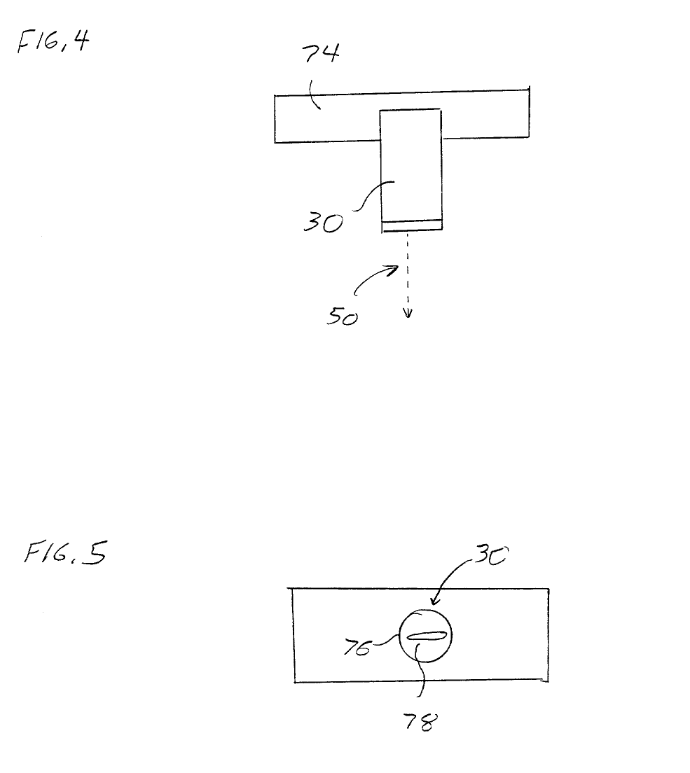

FIG. 5 is a bottom view of the laser emitter 30 in the preferred embodiment. The laser emitter includes a lens 76 providing a line template 78. The line template provides an illuminated laser line of a defined length for view on the target position 54.

Although the laser emitter is preferably affixed to the garage door opener 14, the laser emitter may be located in any position on the ceiling 16 of the garage. Additionally, in an alternate embodiment of the present invention, the laser emitter may be affixed to a moveable bracket allowing the laser beam to be emitted and strike a different location downwardly in relationship with the front wall 40.

Additionally, although a motion detector 34 provides the preferred method of actuating the laser emitter, the laser emitter may be actuated by a wide variety of ways. For example, the laser emitter may be actuated by remote control or by actuation of a light or garage door. Although a 3-volt power source is exemplified, the laser emitter may be powered by any electrical power source, such as a DC or AC power source.

The laser alignment system 28 provides many advantages over existing systems. First, the laser alignment system allows use by any vehicle, after initially establishing the placement of the target position 54 within the interior of the vehicle. Additional, no modification or installment of any alignment device is necessary within the vehicle. The laser beam also does not shine directly in the view of the driver, preventing another needless distraction. The laser alignment system also is preferably actuated by a conventional motion detector, preventing unnecessary use of the laser emitter. The laser alignment system may also be easily installed to existing garage door openers.

It is thus believed that the operation and construction of the present invention will be apparent from the foregoing description. While the system shown and described has been characterized as being preferred, it will be readily apparent that various changes and modifications could be made therein without departing from the scope of the invention as defined in the following claims.

What is claimed is:

1. A vehicle alignment system for guiding a vehicle into a specified position within an enclosure, the system comprising:
an enclosure having a ceiling;
a laser emitting a generally downward laser beam, said laser affixed to a ceiling of said enclosure; and
a determined position on the vehicle, said determined position not requiring any modification to the vehicle and whereby when the laser beam strikes said determined position, a driver of the vehicle is provided with an indication that the vehicle is located in the specified position within said enclosure.

2. The vehicle alignment system of claim 1 further comprising a means for actuating said laser when the vehicle approaches said determined position.

3. The vehicle alignment system of claim 2 wherein said means for automatically actuating said laser is a motion detector located within said enclosure whereby when the motion detector detects motion within said enclosure, said motion detector automatically sends an actuating signal to said laser to emit the laser beam.

4. The vehicle alignment system of claim 2 wherein said actuating means is a remotely operated actuating device whereby the driver of the vehicle remotely actuates the remotely operated actuating device when approaching said enclosure.

5. The vehicle alignment system of claim 2 wherein said actuating means is a switch located in said enclosure which is manually operated to actuate said laser, thereby causing said laser to emit the laser beam.

6. The vehicle alignment system of claim 2 wherein said actuating means is a switch located near said enclosure which is manually operated to actuate said laser, thereby causing said laser to emit the laser beam.

7. The vehicle alignment system of claim 2 wherein said actuating means is connected to a door opener and is actuated upon actuation of the garage door opener opening a door of said enclosure.

8. The vehicle alignment system of claim 1 further comprising a door opener affixed to said enclosure for opening a door of said enclosure;
wherein said laser is affixed to the door opener.

9. The vehicle alignment system of claim 8 wherein said laser receives power from power being fed to the door opener.

10. The vehicle alignment system of claim 1 wherein said enclosure is a garage.

11. The vehicle alignment system of claim 1 wherein said laser emits a laser beam which provides a lighted line of a defined length.

12. The vehicle alignment system of claim 1 further comprising a second laser for use for a second vehicle utilizing the enclosure.

13. A vehicle alignment system for guiding a vehicle into a specified position within an enclosure, the system comprising:
a light emitter emitting a generally downward light beam, said light emitter affixed to a ceiling of the enclosure; and
a specified target position located on the vehicle, whereby when the light beam strikes the specified target position, a driver of the vehicle is provided with an indication that the vehicle is located at the specified position.

14. The vehicle alignment system for guiding a vehicle of claim 13 wherein said light emitter is a laser emitting device emitting a laser beam.

15. The vehicle alignment system for guiding a vehicle of claim 12 wherein said light emitter is an infrared light emitter emitting an infrared light beam.

16. The vehicle alignment system for guiding a vehicle of claim 13 wherein the enclosure is a garage.

17. A vehicle alignment system for guiding a vehicle into a specified position within an enclosure, the system comprising:
an enclosure having a ceiling;
a laser emitting a generally downward laser beam, said laser affixed to the ceiling of the enclosure;
a motion detector for detecting when the vehicle approaches the specified target position, said motion detector sending a signal to the laser to emit the laser beam; and
a specified target position indicating to a driver of the vehicle when the vehicle is located at the specified position, whereby the laser emits the laser beam on the specified target position to provide an indication to the driver that the vehicle is located in the specified location.
